(19) United States
(12) Patent Application Publication
(10) Pub. No.: US 2012/0196102 A1
(43) Pub. Date: Aug. 2, 2012

(54) Coextruded Cast Film Structures

(75) Inventor: Leonardo Cortes, Webster, TX (US)

(73) Assignee: Fina Technology, Inc., Houston, TX (US)

(21) Appl. No.: 13/017,465

(22) Filed: Jan. 31, 2011

(51) Int. Cl. B32B 27/32

(52) U.S. Cl. 428/213; 428/340

(57) ABSTRACT

A cast multilayer film having a core layer made from ICP polypropylene having a thickness of at least 34% of the cast multilayer film, a first layer adjacent to the core layer and a second layer adjacent to the core layer each made from metallocene-based polyethylene (mPE) and having a thickness of from 1 to 33% of the cast multilayer film. The cast multilayer film has increased stiffness without substantial loss of optical, barrier and strength properties as compared with a film of total equal thickness made from the mPE of the first and second layers. The cast multilayer film has increased optical, barrier and strength properties without substantial loss of stiffness as compared with a film of total equal thickness made from the ICP of the core layer.

### FIELD

The present invention is generally related to polymeric films. More specifically, the present invention is related to coextruded cast polyolefin films having a polypropylene based core.

### BACKGROUND

A variety of products utilize polyolefins materials in various manufacturing processes to create a variety of finished goods including cast and blown films. Cast films are typically used in the wrapping or packaging of various products in commerce. Cast films may be commonly used in many types of applications, such as packaging, stretch films, diaper backing, labels, release liners, toys, games, sporting goods, medical devices, and food containers among many others.

Various cast films can provide toughness but have poor optical properties while others can have good optical properties while having poor strength or barrier properties. It would thus be desirable to have a cast film having a balance of properties.

### SUMMARY

An embodiment of the present invention is a multilayer non-oriented cast film having a core layer that includes an impact copolymer (ICP) polypropylene and adjacent first and second layers of metallocene-based polyethylene (mPE). The core layer is at least 34% of the thickness of the cast film and each first and second layer ranges from 1 to 33% of the thickness of the cast film. The cast film has increased stiffness without substantial loss of optical, barrier and strength properties as compared with a film of total equal thickness absent the core layer. The cast film has increased optical, barrier and strength properties without substantial loss of stiffness, as compared with a film of total equal thickness absent the first and second layers. The core layer and the first and second skin layers can be coextruded to form a cast multilayer film.

The core layer can also include, along with the ICP, a polypropylene in amounts of less than 50% by weight selected from polypropylene homopolymers, polypropylene random copolymers, or combinations thereof.

In an embodiment the core layer ranges in thickness between 10 to 150 microns and each first and second layer ranges in thickness between 3.5 to 50 microns. The present invention also includes articles made from the multilayer non-oriented cast film.

### BRIEF DESCRIPTION OF DRAWINGS

FIG. 1 illustrates a web graph comparison of the properties of a neat mPE cast film vs. a three layer mPE/ICP/mPE coextruded cast film of the present invention.

FIG. 2 illustrates a web graph comparison of the properties of a neat ICP cast film vs. a three layer mPE/ICP/mPE coextruded cast film of the present invention.

FIG. 3 illustrates a web graph comparison of the properties of a neat mPE cast film vs. a three layer mPE/ICP/mPE coextruded cast film of the present invention.

FIG. 4 illustrates a web graph comparison of the properties of a neat ICP cast film vs. a three layer mPE/ICP/mPE coextruded cast film of the present invention.

### DETAILED DESCRIPTION

Disclosed herein are non-oriented cast films having a polyolefin core, or base layer, and skin layers, or outer layers, positioned over the polyolefin core. Also disclosed are coextruded cast film structures having a core layer and external skin layers and having improved mechanical properties. In an embodiment, the present invention includes a multilayer cast film having a propylene-containing core layer and at least one layer positioned adjacent to each side of the core layer. In an embodiment, the skin layers are made from metallocene-based polyethylenes (mPE) and the core layer is made from impact copolymer (ICP) polypropylene.

In an embodiment, the core layer consists of at least 50 wt % ICP based on the total weight of the core layer, optionally at least 75 wt % ICP, optionally at least 90 wt % ICP, optionally at least 95 wt % ICP. ICP polypropylene refers to rubber modified copolymer of polypropylene, in which the polypropylene is modified with a second polyolefin. In an embodiment, the ICP polypropylene may be selected from the group of commercially available ICP polypropylenes. In another embodiment, the ICP polypropylene used in the core layer is selected from the group of ICP polypropylene sold under the product reference numbers 4280, 4320, 4520, 4720, 5571, 5720 and 5724 and combinations thereof, all of which are commercially available from Total Petrochemicals, Inc. Methods of making ICPs are well known in the art, for instance, in one non-limiting embodiment methods and techniques are described in U.S. Pat. No. 6,657,024, incorporated herein by reference, may be used.

Polypropylene impact copolymers (ICP) are bi-phasic polymers wherein a polypropylene homopolymer phase or component is joined to a copolymer phase or component. ICP show distinct homopolymer phases that are interrupted by short sequences or blocks having a random arrangement of ethylene and propylene. In comparison to random copolymers, the block segments comprising a copolymer of propylene and ethylene (also referred to as an ethylene/propylene rubber EPR) may have certain polymeric characteristics (e.g., intrinsic viscosity) that differ from that of the copolymer as a whole. In an embodiment, the EPR portion of the ICP comprises greater than 5 wt % of the ICP, optionally greater than 10 wt % of the ICP, optionally from 10 wt % to 20 wt % of the ICP. The amount of ethylene present in the EPR portion of the ICP may be from 30 wt % to 50 wt %, optionally from 40 wt % to 45 wt % based on the total weight of the EPR portion.

The ICP that is the primary or only polymer used in the core layer may be one having a density range from 0.88 to 0.93 g/cm³, optionally from 0.89 to 0.92 g/cm³, and, optionally from 0.9 to 0.91 g/cm³. In an embodiment, the ICP may have a polydispersity from 4 to 12, optionally from 5 to 10. In an embodiment, the ICP may have xylene solubles of 25% or less. In another embodiment, the xylene solubles may range from 1 to 25 wt %, optionally 5 to 15 wt %. In an embodiment, the ICP may have a melting point ranging from 155 to 170° C., optionally from 158 to 166° C., optionally from 160 to 165° C. And in still another non-limiting embodiment the ethylene content of the ICP may range from 7 to 15 wt %, and optionally from 9 to 14 wt %.

In another embodiment, the ICP polypropylene may have a melt flow rate (MFR) ranging from 0.1 to 40 g/10 min. In an alternative embodiment, the ICP polypropylene may have a MFR ranging from 1 to 30 g/10 min, optionally from 3 to 20 g/10 min, optionally from 5 to 10 g/10 min. The ICP can have a weight average molecular weight distribution (MWD) ranging from 280,000 to 840,000, alternatively in another non-limiting embodiment ranging from 320,000 to 780,000, and alternatively in another non-limiting embodiment ranging from 420,000 to 700,000.

In an embodiment, an ICP polypropylene is a majority of the core layer and is combined with a polypropylene homopolymer, a random copolymer, or combinations thereof that make up less than half of the core layer. In an embodiment, the core layer consists essentially of an ICP polypropylene.

In an embodiment, the ICP polypropylene in the core layer can be combined with a polypropylene homopolymer. In an embodiment, a polypropylene homopolymer suitable for use in this disclosure may have a density of from 0.895 g/cc to 0.920 g/cc, optionally from 0.900 g/cc to 0.915 g/cc, and optionally from 0.905 g/cc to 0.915 g/cc as determined in accordance with ASTM D-1505; a melting temperature of from 150° C. to 170° C., optionally from 155° C. to 168° C., and optionally from 160° C. to 165° C. as determined by differential scanning calorimetry (DSC); a melt flow rate of from 0.5 g/10 min. to 30 g/10 min., optionally from 1.0 g/10 min. to 20 g/10 min., and optionally from 5.0 g/10 min. to 15 g/10 min. as determined in accordance with ASTM D-1238 condition “L”.

Examples of polypropylene homopolymers suitable for use in this disclosure include without limitation 3371, 3271, 3270, 3276, 3462, 3571, 3576X, and 3761, which are polypropylene homopolymers commercially available from Total Petrochemicals USA, Inc.

In an embodiment, the ICP polypropylene in the core layer can be combined with a polypropylene random copolymer (RCP), for example a copolymer of propylene with one or more alpha olefin monomers such as ethylene, butene, hexene, etc. In an embodiment, the polypropylene is a random ethylene-propylene (C₂/C₃) copolymer (REPC) and may comprise of from 0.1 wt % to 10 wt % ethylene, optionally from 2 wt % to 7 wt % ethylene optionally from 2 wt % to 6 wt % ethylene.

In an embodiment, a REPC suitable for use in blending with the ICP polypropylene in the core layer may have a density of from 0.890 g/cc to 0.920 g/cc, optionally from 0.895 g/cc to 0.915 g/cc, and optionally from 0.900 g/cc to 0.910 g/cc as determined in accordance with ASTM D-1505. In an embodiment, a REPC may have a melt flow rate of from 0.5 g/10 min. to 40 g/10 min., optionally from 1 g/10 min. to 20 g/10 min., and optionally from 5 g/10 min. to 15 g/10 min, as determined in accordance with ASTM D-1238 condition “L.” The REPC may have a melting point temperature of from 100° C. to 165° C., optionally from 110° C. to 155° C., optionally from 128° C. to 148° C. Furthermore, the REPC may have a molecular weight distribution of from 1 to 10, optionally from 2 to 9, optionally from 3 to 8. The melting point range is indicative of the degree of crystallinity of the polymer while the molecular weight distribution refers to the relation between the number of molecules in a polymer and their individual chain length.

In ethylene-propylene random copolymers, the ethylene molecules are inserted randomly into the polymer backbone between repeating propylene molecules, hence the term random copolymer. The ethylene units do not have a tacticity as they do not have any pendant units, just four hydrogen (H) atoms attached to a carbon backbone (C—C). In an embodiment, a RCP that can be blended with the ICP in the core layer is TPI 8573, which is a polypropylene random copolymer (RCP) commercially available from Total Petrochemicals, Inc.

The skin layers of the cast film are made using a metallocene-based polyethylene. Metallocene-based polyethylene (mPE) refers to polyethylene that is produced by homogenous catalyst(s) that employ metallocenes. Metallocene catalysts generally refer to homogenous catalysts having a transition metal situated between to organic rings.

Metallocene catalysts are coordination compounds or cyclopentadienyl groups coordinated with transition metals through π-bonding. Metallocene catalysts are often employed as unsupported or homogenous catalysts, although they may also be employed in supported catalyst components. In a specific embodiment, metallocene catalysts are composed of two cyclopentadiene-type rings bonded to a transition metal. Metallocene catalysts may be used with aluminoxanes as cocatalysts or activators, in one non-limiting embodiment methylaluminoxane (MAO). In an embodiment, the cyclopentadiene-type rings are bound may be bound to a metal selected from the group of hafnium, lanthanoid, and transition metals of groups IVA, VA, and VIA. In an embodiment, the metallocene catalyst of the present invention may include those described in U.S. Pat. Nos. 6,559,089, to Razavi, incorporated by reference herein in their entirety.

In an embodiment, the metallocene-based polyethylene is selected from the group of metallocene-based linear low density polyethylene (mLLDPE), metallocene-based medium density polyethylene (mMDPE), and metallocene-based high density polyethylene (mHDPE), and combinations thereof. The density of the metallocene-based polyethylene is observed at 23° C. using the procedures of ASTM D 1505. In an embodiment, the skin layer is a metallocene-based polyethylene having a density of at least 0.9 g/cm³. In an alternative embodiment, the skin layer is a metallocene-based polyethylene having a density ranging from 0.920 to 0.960 g/cm³. In a further embodiment, the skin layer is a metallocene-based polyethylene having a density ranging from 0.930 g/cm³ to 0.950 g/cm³.

In an embodiment, the mPE has a melt index (MI) of at least 0.1 g/10 min. In another embodiment, the mPE has a MI of from 0.1 to 10 g/10 min. In an alternative embodiment, the metallocene-based polyethylene has a MI ranging from 0.5 to 5.0 g/10 min. In a further embodiment, the metallocene-based polyethylene has a MI ranging from 0.7 to 4.0 g/10 min. The melt index (MI) of the mPE is measured using the procedures of ASTM D 1238 at 190° C. using a load of 2.16 kg. The mPE may be one having a melting point of 100° C. to 135° C., optionally in another non-limiting embodiment ranging from 115° C. to 130° C. The mPE can have a weight average molecular weigh distribution (MWD) ranging from 30,000 to 110,000, optionally ranging from 40,000 to 100,000, and optionally ranging from 50,000 to 90,000.

In an embodiment, the metallocene-based polyethylene is selected from the group of TPI M2710EP, TPI M3410EP, TPI M3427, and TPI 4040, and any combinations thereof, all commercially available from Total Petrochemicals.

Blends of polymers may be used in the core layer and/or skin layers of the film structures, and the blends may be prepared using technologies known in the art, such as the mechanical mixing of the polyolefins using high-shear internal mixers of the Banbury type, or by mixing directly in the extruder. Suitable extruders include, but are not limited to, single screw co-rotating twin-screws, contra-rotating twin-screws, BUSS extruders, and the like.

The polymers and blends of polymers may also contain various additives capable of imparting specific properties to the articles the blends are intended to produce. Additives known to those skilled in the art that may be used in these blends include, but are not necessarily limited to, fillers such as talc and calcium carbonate, pigments, antioxidants, stabilizers, anti-corrosion agents, slip agents, UV stabilizing agents and antiblock agents, etc. In an embodiment, the additives may be present in amounts ranging from 0.01 to 5 wt % of the polymer composition, optionally from 0.01 to 1 wt %, optionally from 0.1 to 0.5 wt %.

The multilayer cast film can be made by methods known in the art. Co-extrusion may be carried out by simultaneously pushing the polymer of the skin layers and the polymer of the core layer through an adjacent die system to form a film with outer layers of the mPE polymer and a core layer of the ICP polymer and be taken up onto a chill roller where it is cooled to produce a cast film. There can be multiple extruders that together produce multiple cast films that can be collectively taken up onto a chill roller where it is cooled to produce a cast film. In an embodiment, the cast films of the present invention may be prepared by separately, but concurrently, extruding the polypropylene core layer and the skin layers. The separate layers may then be joined after extrusion but before cooling to form the cast film.

In an embodiment, the co-extruded cast film structure has a core layer making up at least 34% of the structure's total thickness, and the skin layer on each side of the core layer is from 1 to 33% of the total structure thickness. Optionally the core layer can range from 34 to 80% of the structure's total thickness, optionally from 40 to 60%. Optionally each skin layer can range from 10 to 33% of the structure's total thickness, optionally from 20 to 30%. In one non-limiting embodiment the co-extruded cast film structure has a core layer ranging in thickness between 10 to 150 microns, and the skin layer ranges in thickness between 3.5 to 50 microns.

In an embodiment, the cast films of the present invention include three layer A/B/A cast films having two skin layers, A, on either side of the core B ICP polypropylene layer where the skin layers are the same mPE. In another embodiment, the cast films of the present invention include three layer A/B/C cast films having two skin layers, A and C, on either side of the core B ICP polypropylene layer where the skin layers are differing mPE compositions.

In an embodiment, the films of the present invention have improved stiffness and impact resistance without significant loss of optics and barrier properties when compared to a neat mPE cast film of equal thickness. In an embodiment, improved stiffness measured by the 1% secant modulus as determined by ASTM procedure D882 shows an increase of at least 20%, optionally at least 30%, optionally at least 40%.

In an embodiment, the films of the present invention have a haze as determined by ASTM procedure D1003 of less than 50%, optionally less than 40%. In a further embodiment, the films of the present invention have a haze ranging from 20 to 40%. In an even further embodiment, the films of the present invention have a haze ranging from 25 to 35%. In an embodiment, the films of the present invention have a gloss 45° as determined by ASTM procedure D2457 of at least 30. In another embodiment, the films of the present invention have a gloss 45° of at least 40. In a further embodiment, the films of the present invention have a gloss 45° ranging from 30 to 65. In an even further embodiment, the films of the present invention have a gloss 45° ranging from 40 to 55.

The cast films of the present invention may have improved moisture barrier properties. In an embodiment, the films of the present invention have a water vapor transmission rate (WVTR) at 0.5 mil of less than 0.5 g/100 in²/day. In another embodiment, the films of the present invention have a water vapor transmission rate (WVTR) at 0.5 mil of less than 0.45 g/100 in²/day. In a further embodiment, the films of the present invention have a WVTR at 0.5 mil ranging from 0.3 to 0.5 g/100 in²/day. The water vapor transmission rate (WVTR) is measured using the procedures of ASTM F-1249.

In an embodiment, the cast films of the present invention have improved mechanical properties, specifically improved tear strength, tensile strength, and secant modulus, each as determined by ASTM procedure D882 when compared to a neat mPE cast film of equal thickness. In an embodiment, the films of the present invention have a tear strength in the machine direction (MD) of at least 70 g/2 mil. In another embodiment, the films of the present invention have a tear strength in the machine direction of at least 80 g/2 mil. In a further embodiment, the films of the present invention have a tear strength in the machine direction ranging from 70 to 120 g/2 mil. In an even further embodiment, the films of the present invention have a tear strength in the machine direction ranging from 80 to 110 g/2 mil. In an embodiment, the films of the present invention have a tear strength in the transverse direction (TD) of at least 130 g/2 mil. In another embodiment, the films of the present invention have a tear strength in the transverse direction of at least 150 g/2 mil. In a further embodiment, the films of the present invention have a tear strength in the transverse direction ranging from 155 to 275 g/2 mil. In an embodiment, the films of the present invention have a TD/MD ratio ranging from 1.0 to 5.0. In another embodiment, the films of the present invention have a TD/MD ratio ranging from 1.0 to 3.5.

In an embodiment, the cast films of the present invention have a tensile strength in the machine direction of at least 3 kpsi. In an embodiment, the films of the present invention have a tensile strength in the machine direction of less than 6 kpsi. In a further embodiment, the films of the present invention have a tensile strength in the machine direction ranging from 4 to 5.5 kpsi. In an embodiment, the cast films of the present invention have a tensile strength in the transverse direction of at least 3 kpsi. In an embodiment, the films of the present invention have a tensile strength in the transverse direction of less than 5 kpsi. In a further embodiment, the films of the present invention have a tensile strength in the transverse direction ranging from 3.5 to 4.5 kpsi.

Also, the films of the present invention have demonstrated an improved impact resistance. In an embodiment, the films of the present invention have demonstrated an improved impact resistance over polyethylene films not containing a polypropylene impact copolymer core. In another embodiment, the films of the present invention have demonstrated at least a 5% improvement in impact resistance over polyethylene films not containing a polypropylene impact copolymer core. In a further embodiment, the films of the present invention have demonstrated an improvement ranging from 10 to 30% in impact resistance over polyethylene films not containing a polypropylene impact copolymer core.

In an embodiment, polymer pellets or fluff may be heated in an extruder to a temperature of from 180° C. to 350° C., optionally from 190° C. to 280° C., optionally from 200° C. to 250° C. The molten plaque may exit through a die and be taken up onto a chill roller where it is cooled to produce a cast film. There can be multiple extruders that extrude more than one layer that are contacted together to produce a multilayered film that can be collectively taken up onto a chill roller where it is cooled to produce a multilayered cast film. Bonding layers or adhesives are generally not required but can be optionally used for particular embodiments.

Articles may be formed from the films disclosed herein. The articles that may be formed with these co-extruded films include, but are not limited to, stretch films, health and hygiene articles (e.g., diapers), release liners, tapes, stand-up pouches, shrink wrap, heavy-duty bags and shipping sacks, carrier envelopes, FFS film, food packaging, tissue and towel overwraps, pet food backs, industrial films, and the like.

### EXAMPLES

### Example 1

In this example, cast film samples of 3-layered coextruded structures using mPEs as skin layers and ICP as a core layer were coextruded to a cast multilayer film having a total thickness of 2 mil and with a 25/50/25 layer distribution. For comparative purposes, individual 2 mil monolayer films were also made.

The metallocene-based polyethylene materials used for the skin layers were M3427 and M4040, commercially available from Total Petrochemicals. The mPE materials have properties as shown in Table 1. The polypropylene impact copolymer used for the core layer was 5571, commercially available from Total Petrochemicals, having properties as shown in Table 2. The structure and thickness of the multilayer cast film is shown in Table 3. The properties for the cast film samples made in this experiment, both monolayer and multilayer, are shown in Table 4.

TABLE 1
Skin Materials

| mPE | Density (g/cm³) | MI (g/10 min) |
|---|---|---|
| M3427 | 0.934 | 2.7 |
| M4040 | 0.940 | 4.0 |

TABLE 2
Core Material

| ICP Polypropylene | Density (g/cm³) | MFR (g/10 min) |
|---|---|---|
| 5571 | 0.905 | 7.0 |

TABLE 3
Structures Used in Examples

| | Example 1 | |
|---|---|---|
| Skin layer A (microns) | mPE | (12.5) |
| Core layer B (microns) | PP ICP | (25) |
| Skin layer C (microns) | mPE | (12.5) |
| Total target thickness, | 2 | (50) |
| mil (microns) | | |

TABLE 4
Film Properties

| Core | | Neat | Neat | Neat | 5571 | 5571 |
|---|---|---|---|---|---|---|
| Skins | | M4040 | M3427 | 5571 | M4040 | M3427 |
| Haze | % | 25.8 | 21.7 | 82.2 | 32.8 | 28.1 |
| Gloss, 45° | | 48.2 | 53.5 | 6.2 | 43.2 | 52.3 |
| WVTR | g/100in²/day | 0.35 | 0.40 | 0.57 | 0.35 | 0.45 |
| Dart | g | 138 | 161 | 347 | 181 | 182 |
| MD Tear | g | 67 | 118 | 186 | 105 | 86 |
| TD Tear | g | 180 | 332 | 212 | 163 | 255 |
| TD/MD Tear Ratio | | 2.7 | 2.8 | 1.1 | 1.5 | 3.0 |
| 1% Secant | kpsi | 56 | 43 | 94 | 79 | 95 |
| Tensile Strength, Break | psi | 4,928 | 4,859 | 3,777 | 4,426 | 5,318 |
| Elongation, Break | % | 995 | 978 | 699 | 840 | 822 |

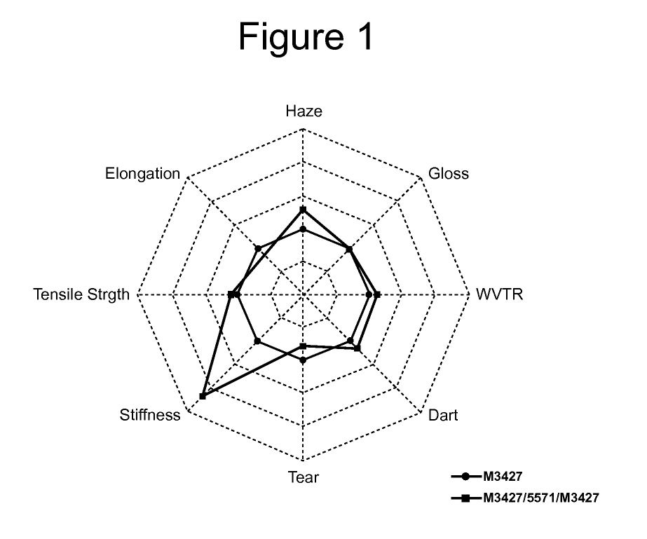

Comparative web graphs of the multilayer films versus the neat mPE films and neat ICP film are shown in FIGS. 1-4.

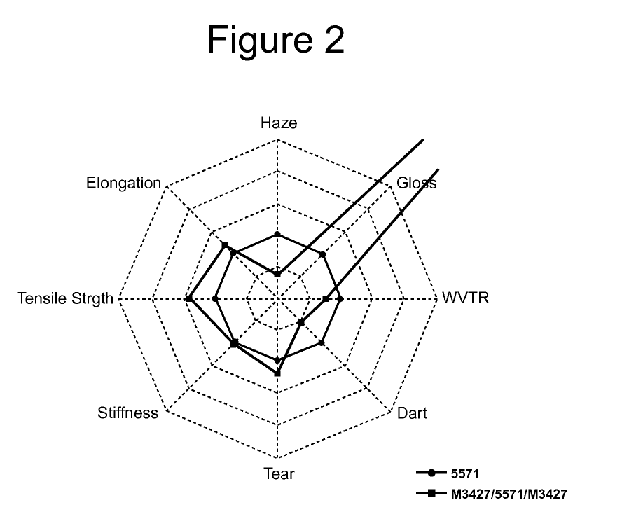

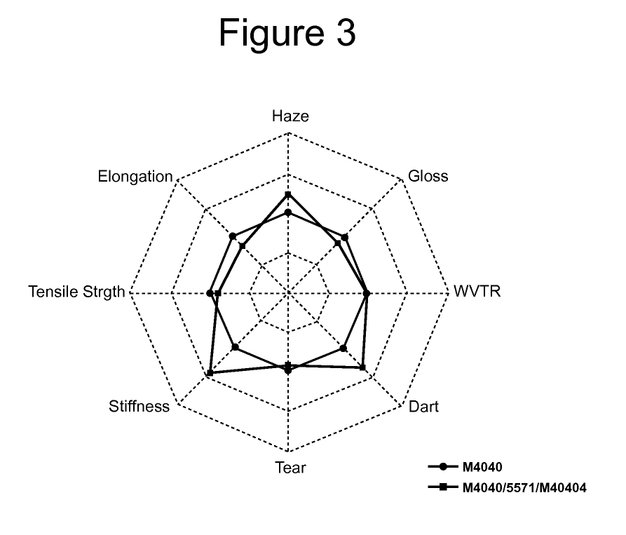

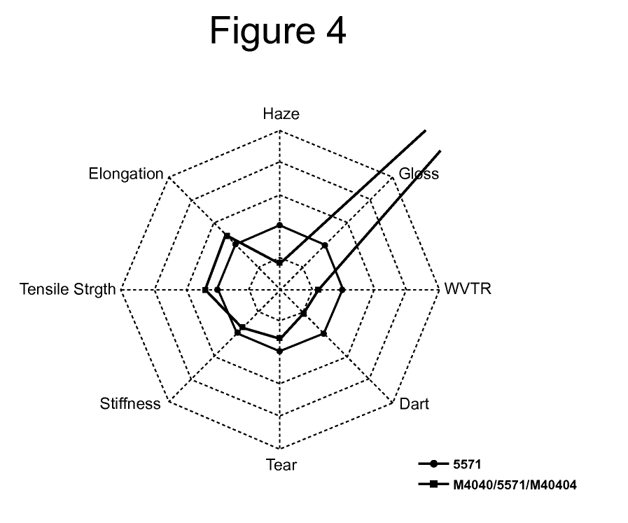

Referring to FIGS. 1 and 3, the multilayer cast films demonstrate a substantial improvement in stiffness without a substantial loss of optics, strength and barrier (WVTR) properties vs. neat mPE. Referring to FIGS. 2 and 4, the multilayer cast films demonstrate a substantial improvement in optics vs. neat ICP. Additionally, lower WVTR (better barrier), higher tensile strength and equivalent stiffness were observed in the coextruded structures as compared to the neat ICP reference film. The balance of properties as shown in the multilayer cast films were surprising in the relative amount of improvement in stiffness that was obtained while having limited reductions in the other properties.

Table 5 presents the ASTM Film Test Methods Used for measuring the properties referred to herein.

TABLE 5

| Property | ASTM Procedure |
|---|---|
| Tensile Strength, Elongation, Secant Modulus | D882 |
| Haze | D1003 |
| Gloss | D2457 |
| Melt Flow Rate | D1238—230° C./2.16 kg |
| Melting Point | D3418 |
| Melt Index | D1238—190° C./2.16 kg |

As used herein, the term “cast film” refers to a film made from one or more polyolefin that is extruded in a film or sheet structure but is not oriented by substantial stretching in either the machine or transverse direction after crystallization.

As used herein, the term “metallocene,” or “metallocene catalyst,” refers to organometallic coordination compounds containing two cyclopentadienyl rings bonded to a transition metal atom.

As used herein, the term “metallocene-based polyethylene,” or “mPE,” refers to polyethylene produced by the use of a metallocene catalyst.

As used herein, the term “polyethylene” refers to a class of polymers derived primarily from ethylene monomers.

As used herein, the term “polypropylene” refers to a class of polymers derived primarily from propylene monomers.

As used herein, the term “isotactic polypropylene” refers to polypropylene in which all the substituents are located on the same side of the polymer chain.

As used herein, the term “syndiotactic polypropylene” refers to polypropylene in which the substituents have alternating positions along the polymer chain.

As used herein, the term “substantial reduction in optical properties” refers to an increase in haze of more than 30% (comparative between two samples, not actual haze measurement) along with a decrease in gloss of more than 15% when tested between comparative 2 mil cast films per ASTM standards.

As used herein, the term “substantial reduction in barrier properties” refers to an increase in the WVTR of more than 15% when tested between comparative 2 mil cast films per ASTM standards.

As used herein, the term “substantial reduction in strength” refers to a decrease in tensile strength of more than 15% when tested between comparative 2 mil cast films per ASTM standards.

As used herein, the terms “substantial reduction in stiffness” and “substantial increase in stiffness” refer to a change in the 1% secant modulus of more than 20% when tested between comparative 2 mil cast films per ASTM standards.

As used herein, the term “substituent” refers to an atom or group of atoms substituted in place of a hydrogen atom on a polymer chain.

It is to be understood that while illustrative embodiments have been depicted and described, modifications thereof can be made by one skilled in the art without departing from the spirit and scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the invention may be devised without departing from the basic scope thereof and the scope thereof is determined by the claims that follow.

What is claimed is:

1. A cast multilayer film, comprising:
a core layer having a first and second side, comprising a polypropylene based impact copolymer (ICP);
a first layer adjacent to and in contact with the first side of the core layer;
a second layer adjacent to and in contact with the second side of the core layer;
wherein the first and second layers comprise metallocene-based polyethylene (mPE);
wherein the core layer has a thickness of at least 34% of the cast multilayer film and each first and second layer has a thickness of from 1 to 33% of the thickness of the cast multilayer film;
wherein the cast multilayer film has increased stiffness without substantial loss of optical, barrier and strength properties as compared with a film of total equal thickness made from the mPE of the first and second layers;
wherein the film has increased optical, barrier and strength properties without substantial loss of stiffness as compared with a film of total equal thickness made from the ICP of the core layer.

2. The film of claim 1, wherein the film has increased stiffness of at least 20% as compared with a structure of total equal thickness made from the mPE of the first and second layers.

3. The film of claim 1, wherein the film has increased stiffness of at least 30% as compared with a structure of total equal thickness made from the mPE of the first and second layers.

4. The film of claim 1, wherein the ICP polypropylene has a density of from 0.88 to 0.93 gr/cm³, a polydispersity from 4 to 12, and a melt flow rate ranging from 0.1 to 40 g/10 min.

5. The film of claim 1, wherein in addition to the ICP polypropylene, the core layer also comprises a polypropylene other than ICP, in amounts of less than 50 wt % of the core layer, selected from the group consisting of polypropylene homopolymers, polypropylene random copolymers, and combinations thereof.

6. The film of claim 1, wherein the metallocene-based polyethylene has a density of at least 0.900 g/cm³ and a melt index ranging from 0.1 to 10.0 g/10 min.

7. The film of claim 1, wherein the core layer ranges in thickness between 10 to 150 microns and where each first and second layer ranges in thickness between 3.5 to 50 microns.

8. The film of claim 1, wherein the cast multilayer film has a 1% secant modulus of at least 60 kpsi for a 2 mil film.

9. The film of claim 1, wherein the cast multilayer film has a 1% secant modulus of at least 75 kpsi for a 2 mil film.

10. The film of claim 1, wherein the cast multilayer film has a WVTR at 0.5 mil of less than 0.5 g/100 in²/day.

11. The film of claim 1, wherein the cast multilayer film has a WVTR at 0.5 mil of less than 0.45 g/100 in²/day.

12. The film of claim 1, wherein the cast multilayer film has a tensile strength of at least 4.0 kpsi and a 1% secant modulus of at least 75 kpsi.

13. The film of claim 1, wherein the cast multilayer film has a tear strength in the machine direction of at least 70 g/2 mil and a tear strength in the transverse direction of at least 150 g/2 mil.

14. The film of claim 1, wherein the core layer comprises at least 40% of the thickness of the cast multilayer structure and each first and second layer is at least 20% of the thickness of the cast multilayer film.

15. An article made using the cast multilayer film of claim 1.

16. A cast film comprising:
a core layer of polypropylene based impact copolymer (ICP);
two outer layers comprising metallocene-based polyethylene (mPE) that have a density of greater than 0.900 g/cm³, wherein the core layer is positioned between the two outer layers;
wherein the cast film is made by coextruding the outer layers and the core layer;
wherein the cast film has a 1% secant modulus of at least 75, gloss of at least 40, and a WVTR at 0.5 mil of less than 0.5 g/100 in²/day.

17. The cast film of claim 16, wherein the cast film has a tensile strength of at least 4 kpsi.

18. The cast film of claim 16, wherein the cast film has a tear strength in the machine direction of at least 70 g/2 mil and a tear strength in the transverse direction of at least 150 g/2 mil.

19. The cast film of claim 16, wherein the core layer is at least 34% of the thickness of the film and each outer layer ranges from 1 to 33% of the thickness of the cast film.

20. The cast film of claim 16, wherein the core layer is at least 40% of the thickness of the film and each outer layer is at least 20% of the thickness of the cast film.
